(19) United States
(12) Patent Application Publication
(10) Pub. No.: US 2022/0006149 A1
(43) Pub. Date: Jan. 6, 2022

(54) POWER STORAGE DEVICE

(71) Applicant: TOYOTA JIDOSHA KABUSHIKI KAISHA, Toyota-shi (JP)

(72) Inventor: Seiya ISHIKURA, Toyota-shi (JP)

(73) Assignee: TOYOTA JIDOSHA KABUSHIKI KAISHA, Toyota-shi (JP)

(21) Appl. No.: 17/365,111

(22) Filed: Jul. 1, 2021

(30) Foreign Application Priority Data
Jul. 6, 2020 (JP) 2020-116304

(51) Int. Cl. H01M 50/242

(52) U.S. Cl. CPC H01M 50/242; H01M 2220/20

(57) ABSTRACT

A power storage device includes: a housing case; a power storage module including a plurality of power storage cells disposed inside the housing case; and a plurality of resin frames each disposed between the plurality of power storage cells. A contact piece is formed on each of the resin frames. The contact piece is in contact with an inner circumferential surface of the housing case and elastically deforms.

This nonprovisional application is based on Japanese Patent Application No. 2020-116304 filed on Jul. 6, 2020 with the Japan Patent Office, the entire contents of which are hereby incorporated by reference.

### BACKGROUND

### Field

The present disclosure relates to a power storage device.

### Description of the Background Art

Conventionally, various types of power storage devices have been proposed.

For example, a power storage device disclosed in Japanese Patent Laying-Open No. 2017-050121 includes a housing case, a plurality of power storage cells disposed inside the housing case, and a resin frame disposed between the power storage cells.

The resin frame includes: a frame body disposed between the power storage cells; and a first coupling portion and a second coupling portion each formed so as to protrude from a lower portion of the frame body. In the arrangement direction in which the power storage cells are arranged, the first coupling portions are coupled to each other, and similarly, the second coupling portions are coupled to each other.

The first coupling portion and the second coupling portion are spaced apart from each other in the width direction of each power storage cell. The housing case has a bottom surface, on which a first seal member supporting a lower end portion of the first coupling portion and a second seal member supporting a lower end portion of the second coupling portion are disposed. Further, a cooling air passage is formed between the first coupling portions and the second coupling portions. Cooling air flows through the cooling air passage to thereby cool each power storage cell.

According to the above-described power storage device, when the power storage device vibrates in the up-down direction, the vibration propagates to each power storage cell through the coupling portions. An electrode body is accommodated in each power storage cell. Thus, the vibration applied to each power storage cell may damage the electrode body to thereby deteriorate each power storage cell.

### SUMMARY

The present disclosure has been made in view of the above-described problems, and an object of the present disclosure is to provide a power storage device capable of suppressing propagation of vibration, which is applied to the power storage device, to power storage cells.

A power storage device according to the present disclosure includes: a housing case; a power storage module including a plurality of power storage cells disposed inside the housing case; and a plurality of resin frames each disposed between the power storage cells. A contact piece is formed on each of the resin frames. The contact piece is in contact with an inner circumferential surface of the housing case and elastically deforms.

According to the above-described power storage device, when the power storage device vibrates, the contact piece elastically deforms, and thereby, the vibration energy transmitted to each power storage cell can be reduced.

The housing case has a bottom surface provided with a recessed portion that opens upward. The power storage module is disposed to close an opening of the recessed portion. The power storage module closes the opening of the recessed portion to form a cooling passage through which cooling air flows. The contact piece is formed to come into contact with a portion of the inner circumferential surface, the portion being adjacent to an opening edge of the opening.

According to the above-described power storage device, the contact piece is pressed by the power storage cell against the inner surface of the housing case. This increases the contact pressure between the inner surface of the housing case and the contact piece, so that the sealing performance achieved by the contact piece can be ensured.

The power storage cells are arranged in an arrangement direction. Both ends of the power storage module are fixed to the housing case in the arrangement direction. The contact piece formed on one of the resin frames that is located at a center position in the arrangement direction is higher in modulus of elasticity than the contact piece formed on one of the resin frames that is located on one end position in the arrangement direction.

In the power storage cells arranged as described above, when vibration occurs in a manner in which the amplitude becomes larger at the center in the arrangement direction, the contact piece located at the center is less likely to deform. Thereby, such an amplitude becoming larger at the center can be suppressed.

Each of the resin frames includes: a bottom plate disposed on a lower surface of each of the power storage cells; and a coupling portion formed on the bottom plate.

The coupling portions of the resin frames adjacent to each other are coupled to each other. The contact piece protrudes downward from a lower surface of the bottom plate. The contact piece protrudes downward below the coupling portion. The coupling portion is located apart from the inner circumferential surface of the housing case.

According to the above-described power storage device, the coupling portions are connected to each other, to thereby couple the resin frames to each other. Thus, formation of a gap between the contact pieces formed on each resin frame can be suppressed, so that the sealing performance can be improved.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a perspective view showing a power storage device 1 according to the present embodiment.

FIG. 2 is a cross-sectional side view showing power storage device 1.

FIG. 3 is a cross-sectional view showing power storage device 1.

FIG. 4 is a cross-sectional side view showing a power storage cell 20 and a resin frame 21.

FIG. 5 is a front view showing resin frame 21.

FIG. 6 is a cross-sectional view showing a configuration of a contact piece 38 and a surrounding area thereof.

FIG. 7 is a cross-sectional view showing a configuration of a contact piece 58A as the first modification of contact piece 38 and a surrounding area of contact piece 58A.

FIG. 8 is a cross-sectional view showing a modification of the configuration shown in FIG. 7.

FIG. 9 is a cross-sectional view showing a configuration of a contact piece 58B as the second modification of contact piece 38 and a surrounding area of contact piece 58B.

FIG. 10 is a front view showing a resin frame 66 as a modification of resin frame 21.

FIG. 11 is a cross-sectional side view showing power storage cell 20 and resin frame 66.

### DESCRIPTION OF THE PREFERRED EMBODIMENTS

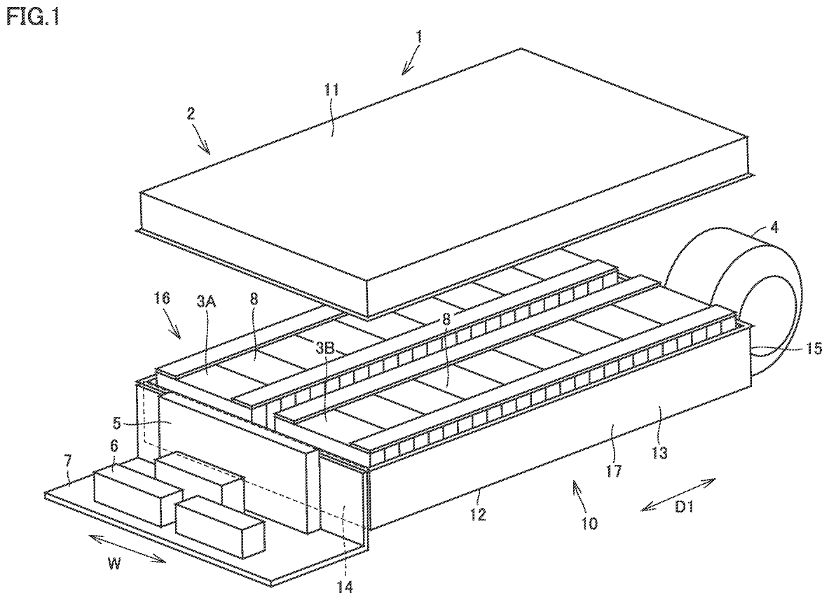

A power storage device according to the present embodiment will be hereinafter described with reference to FIGS. 1 to 11. The same or substantially the same configurations among the configurations shown in FIGS. 1 to 11 will be denoted by the same reference characters, the descriptions thereof will not be repeated.

FIG. 1 is a perspective view showing a power storage device 1 according to the present embodiment. Power storage device 1 includes a housing case 2, power storage modules 3A and 3B, a blower 4, a battery ECU 5, a junction box 6, a bracket 7, and a circuit substrate 8.

Housing case 2 includes a case body 10 and a top plate 11. Case body 10 is formed by aluminum die casting or the like.

Case body 10 includes a bottom plate 12 and a circumferential wall 13. Circumferential wall 13 is formed in an annular shape and formed to rise upward from the outer circumferential edge of bottom plate 12.

Circumferential wall 13 includes end walls 14, 15 and side walls 16, 17. End wall 14 is located at one end in a longitudinal direction D1. End wall 15 is located at the other end in longitudinal direction D1. Side wall 16 is located at one end in a width direction W. Side wall 17 is located at the other end in width direction W. Blower 4 is provided on the outside of end wall 15. End wall 15 is provided with an opening (not shown), through which cooling air is supplied from blower 4 into housing case 2.

Bracket 7 is fixed to the outer side surface of end wall 14. Bracket 7 is formed to extend in the horizontal direction from the outer side surface of end wall 14. Battery ECU 5 and junction box 6 are provided on the upper surface of bracket 7.

Circuit substrate 8 is disposed on the upper surface side of power storage modules 3A and 3B. Temperature sensors and the like provided in power storage modules 3A and 3B are connected to circuit substrate 8.

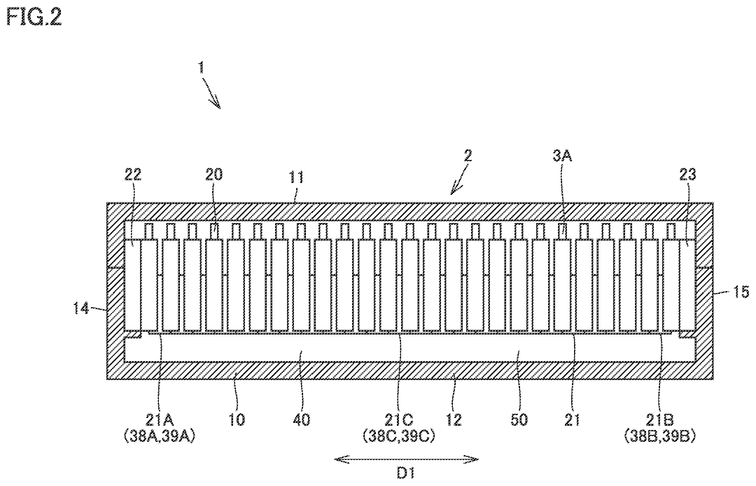

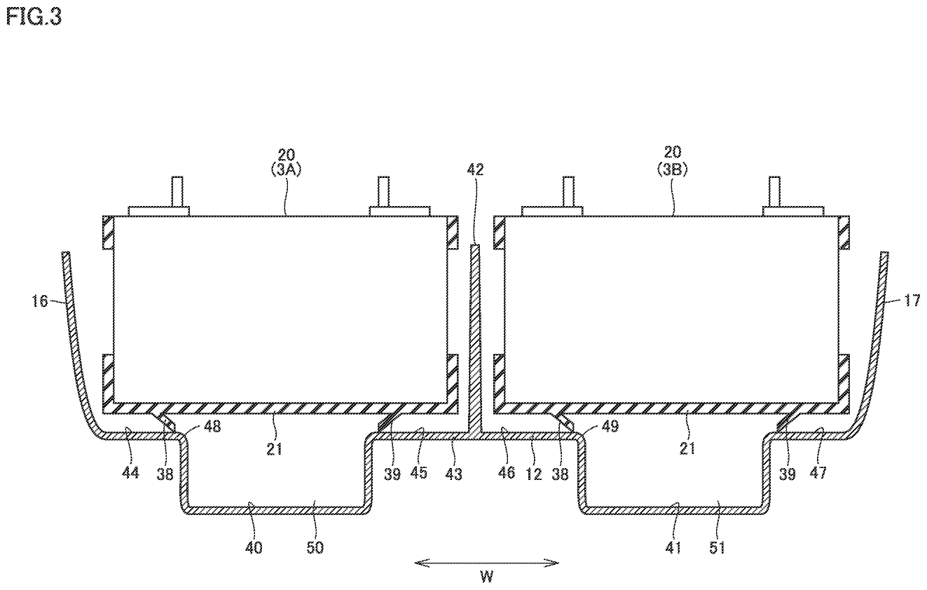

FIG. 2 is a cross-sectional side view showing power storage device 1. FIG. 3 is a cross-sectional view showing power storage device 1. FIG. 2 does not show bracket 7, battery ECU 5, and junction box 6. Referring to FIG. 3, bottom plate 12 of housing case 2 has recessed portions 40 and 41. Recessed portions 40 and 41 each are formed to extend in longitudinal direction D1.

Recessed portion 40 is provided with an opening 48 that opens upward. Recessed portion 41 is provided with an opening 49 that opens upward. Bottom plate 12 has a protruding portion 43 formed between recessed portions 40 and 41. Protruding portion 43 has an upper surface on which a partition plate 42 is formed. Partition plate 42 is formed to extend upward and to extend in longitudinal direction D1.

Side wall 16 is spaced apart in width direction W from the opening edge of opening 48. A mounting surface 44, which is a flat surface, is formed between side wall 16 and the opening edge of opening 48. Similarly, a mounting surface 45 is formed between partition plate 42 and the opening edge of opening 48.

A mounting surface 46 is formed between partition plate 42 and the opening edge of opening 49. A mounting surface 47 is formed also between side wall 17 and the opening edge of opening 49.

Power storage module 3A is provided to close opening 48. Power storage module 3A is disposed on mounting surfaces 44 and 45. Power storage module 3B is provided to close opening 49. Power storage module 3B is disposed on mounting surfaces 46 and 47.

Power storage module 3A closes opening 48 to thereby form a cooling passage 50. Power storage module 3B closes opening 49 to thereby form a cooling passage 51. Cooling air supplied from blower 4 flows through cooling passages 50 and 51.

Since power storage module 3B is configured in the same manner as power storage module 3A, power storage module 3A will be hereinafter mainly described.

In FIG. 2, power storage module 3A includes a plurality of power storage cells 20 arranged in longitudinal direction (arrangement direction) D1, a plurality of resin frames 21, and end plates 22 and 23.

In longitudinal direction D1, end plate 22 is provided at one end of power storage module 3A while end plate 23 is provided at the other end of power storage module 3A.

End plate 22 is in close contact with end wall 14 while end plate 23 is in close contact with end wall 15.

Power storage module 3A is pressed by end walls 14 and 15, and thereby, fixed between end walls 14 and 15.

Also, a spacer such as a shim may be inserted between end wall 14 and end plate 22 or between end wall 15 and end plate 23 so as to ensure the restraining force applied to power storage module 3A.

In this way, both ends of power storage module 3A are fixed while a portion of power storage module 3A that is located between its both ends is not fixed to housing case 2. In other words, power storage module 3A is fixed at its both ends to housing case 2.

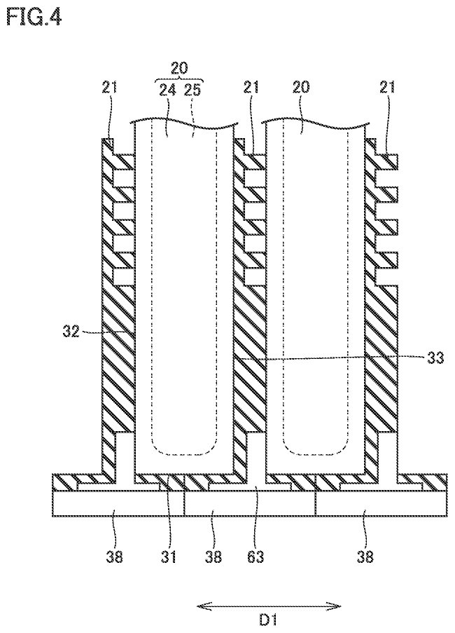

FIG. 4 is a cross-sectional side view showing power storage cell 20 and resin frame 21. Power storage cell 20 includes a case 24 and an electrode body 25. Case 24 is formed, for example, of an aluminum alloy and the like. Electrode body 25 is accommodated in case 24 together with an electrolytic solution. Case 24 is formed in a thin rectangular parallelepiped shape in longitudinal direction D1. Case 24 has an upper surface, a bottom surface 31, and main surfaces 32 and 33. Main surfaces 32 and 33 are arranged in longitudinal direction D1. Resin frame 21 is disposed between power storage cells 20.

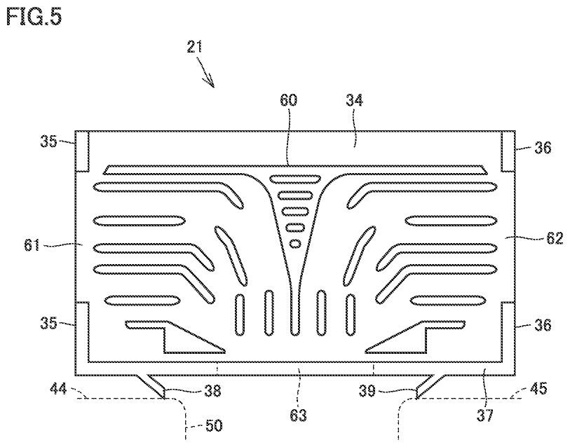

FIG. 5 is a front view showing resin frame 21. Resin frame 21 includes a main wall 34, side walls 35 and 36, a bottom wall 37, and contact pieces 38 and 39.

Main wall 34 is disposed between power storage cells 20. Main wall 34 is provided with a guide rib 60. Side walls 35 and 36 are disposed on the respective side surfaces of case 24. Side wall 35 has a gap 61 while side wall 36 also has a gap 62. Bottom wall 37 is disposed on bottom surface 31 of power storage cell 20. Bottom wall 37 has a gap 63.

Contact pieces 38 and 39 each are formed to protrude downward from the lower surface of bottom wall 37. Contact pieces 38 and 39 are spaced apart from each other in width direction W. Gap 63 is located between contact pieces 38 and 39. Since contact piece 39 is substantially the same as contact piece 38, contact piece 38 will be hereinafter described.

In FIG. 4, contact piece 38 is formed to extend in an elongated shape in longitudinal direction D1. Also, contact pieces 38 on their respective resin frames 21 adjacent to each other in longitudinal direction D1 are located close to each other.

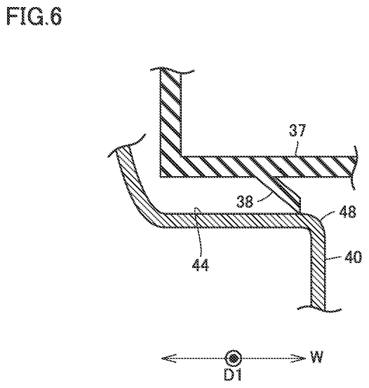

FIG. 6 is a cross-sectional view showing a configuration of contact piece 38 and a surrounding area thereof. Contact piece 38 is inclined so as to approach opening 48 of recessed portion 40 as contact piece 38 extends downward from the lower surface of bottom wall 37. The lower end portion of contact piece 38 is in contact with mounting surface 44. Contact piece 38 elastically deforms as it receives a load from resin frame 21 and power storage cell 20. Thus, the lower end portion of contact piece 38 is in close contact with mounting surface 44.

For example, the plate thickness of contact piece 38 is larger than half the plate thickness of bottom wall 37, and the plate thickness of contact piece 38 is smaller than twice the plate thickness of bottom wall 37.

In the state where contact piece 38 is in contact with mounting surface 44, the distance between mounting surface 44 and the lower surface of bottom wall 37 is larger than the distance between side walls 16 and 35.

In FIG. 2, power storage device 1 includes: a resin frame 21A provided on one end side in longitudinal direction D1; a resin frame 21B provided on the other end side in longitudinal direction D1; and a resin frame 21C provided at the center in longitudinal direction D1.

Resin frame 21A includes contact pieces 38A and 39A. Resin frame 21B includes contact pieces 38B and 39B. Resin frame 21C includes contact pieces 38C and 39C.

Contact piece 38C is higher in modulus of elasticity than each of contact pieces 38A and 38B. In other words, contact piece 38C is less likely to deform than contact pieces 38A and 38B.

For example, contact piece 38C is formed larger in plate thickness than each of contact pieces 38A and 38B, so that contact piece 38C can be higher in modulus of elasticity than each of contact pieces 38A and 38B. Further, resin frame 21C may be made of a material different from the material of resin frames 21A and 21B. Similarly, contact piece 39C is also higher in modulus of elasticity than each of contact pieces 39A and 39B.

Contact pieces 38 and 39 arranged in longitudinal direction D1 may be formed to have modulus of elasticity that increases toward the center of each of power storage modules 3A and 3B in longitudinal direction D1.

(Description of Cooling Effect)

In power storage device 1 configured as described above, blower 4 is driven when power storage modules 3A and 3B are cooled. When blower 4 is driven, cooling air flows through cooling passages 50 and 51.

In FIGS. 4 and 5, the cooling air passes through gap 63 and flows between power storage cell 20 and resin frame 21. The cooling air incoming through gap 63 is guided by guide rib 60 into gaps 61 and 62. In this way, the cooling air flows between power storage cell 20 and resin frame 21, and thereby, power storage cell 20 can be cooled.

In FIG. 5, contact piece 38 is in contact with mounting surface 44 while contact piece 39 is in contact with mounting surface 45, with the result that the cooling air flowing through cooling passage 50 is suppressed from leaking from cooling passage 50. Contact pieces 38 and 39 elastically deform, and the lower end portions of contact pieces 38 and 39 are in close contact with mounting surfaces 44 and 45, respectively. Thus, the sealing performance achieved by contact pieces 38 and 39 is enhanced.

As shown in FIG. 4, since the gap between contact pieces 38 adjacent to each other is so small that leakage of the cooling air from between contact pieces 38 is suppressed. Since contact piece 39 is also formed in the same manner as contact piece 38, contact piece 39 also suppresses leakage of the cooling air.

Also in cooling passage 51, similarly, the contact pieces of power storage module 3B suppress leakage of the cooling air from cooling passage 51.

(Vibration Suppression)

Power storage device 1 configured as described above is mounted, for example, on a vehicle and the like. Also, housing case 2 is fixed, for example, to a front panel and the like of a vehicle. Thus, when the vehicle travels, vibration of the vehicle may be applied to power storage device 1.

As power storage device 1 vibrates, power storage modules 3A and 3B vibrate against housing case 2.

In FIG. 3, when power storage module 3A vibrates in the up-down direction, contact piece 38 elastically deforms, and thereby, the vibration energy of power storage module 3A is consumed as energy that deforms contact piece 38. Thus, the vibration occurring in power storage module 3A can be suppressed.

The vibration of power storage module 3A is suppressed, and thereby, the vibration applied to power storage cell 20 is also suppressed. The vibration of power storage cell 20 is suppressed, and thereby, damage to electrode body 25 of power storage cell 20 can be suppressed. Similarly, also in power storage module 3B, the vibration of power storage module 3B is suppressed, and thereby, damage to the electrode body is suppressed also in power storage module 3B.

The plate thickness of contact piece 38 is larger than half the plate thickness of bottom wall 37, and the plate thickness of contact piece 38 is smaller than twice the plate thickness of bottom wall 37. Bottom wall 37 is formed to have a prescribed thickness so as to support power storage cell 20. On the other hand, when the thickness of contact piece 38 is smaller than half the thickness of bottom wall 37, contact piece 38 may be broken when power storage module 3A vibrates. When the plate thickness of contact piece 38 is larger than twice the plate thickness of bottom wall 37, contact piece 38 is less likely to elastically deform. As a result, vibration is more likely to be transmitted from housing case 2 to power storage module 3A.

In FIG. 2, power storage module 3A is fixed at its both ends to housing case 2. Thus, in longitudinal direction D1, the amplitude occurring at the center of power storage module 3A tends to be larger than the amplitude occurring at each of both ends of power storage module 3A.

On the other hand, each of contact pieces 38C and 39C is higher in modulus of elasticity than each of contact pieces 38A, 38B, 39A and 39B. Therefore, the amplitude becoming larger at the center of power storage module 3A can be suppressed.

In particular, the modulus of elasticity of each of contact pieces 38 and 39 arranged in longitudinal direction D1 increases from both ends of power storage module 3A toward its the center.

Thus, when power storage module 3A vibrates, the amplitude can be suppressed to be small over the entire length of power storage module 3A. Also in power storage module 3B, vibration is suppressed as in power storage module 3A.

The manner in which power storage modules 3A and 3B vibrate differs depending on the natural frequencies of power storage modules 3A and 3B and the frequencies applied to power storage modules 3A and 3B. Thus, for example, depending on the frequency applied to power storage module 3A, power storage modules 3A and 3B may vibrate in a manner in which two antinodes occur (a “node”, an “antinode”, a “node”, an “antinode”, a “node”) in the amplitude. In order to address such a vibration manner, contact pieces 38 and 39 located at a portion corresponding to an antinode may be higher in modulus of elasticity than contact pieces 38 and 39, respectively, located at a portion corresponding to a node.

(First Modification)

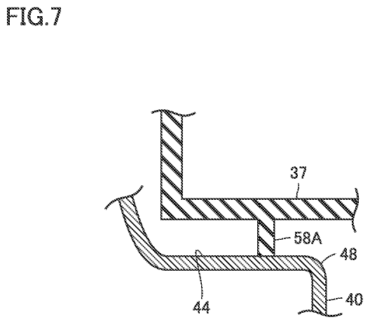

FIG. 7 is a cross-sectional view showing a configuration of a contact piece 58A as the first modification of contact piece 38 and a surrounding area of contact piece 58A. Contact piece 58A is formed to extend downward from the lower surface of bottom wall 37, and the lower end portion of contact piece 58A is in contact with mounting surface 44.

When the load applied to contact piece 58A increases, contact piece 58A elastically deforms so as to buckle. In this way, also in the case of contact piece 58A, contact piece 58A elastically deforms, and thereby, the vibration transmitted from housing case 2 to power storage module 3 can be reduced.

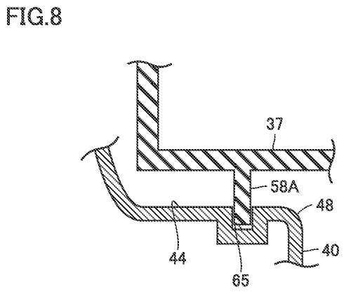

As shown in FIG. 8, an insertion groove 65 into which contact piece 58A is inserted may be formed in mounting surface 44. Insertion groove 65 is formed in an elongated shape in longitudinal direction D1. Since the lower end portion of contact piece 58A is inserted into insertion groove 65, the cooling air flowing through cooling passage 50A can be suppressed from leaking to the outside of cooling passage 50A.

(Second Modification)

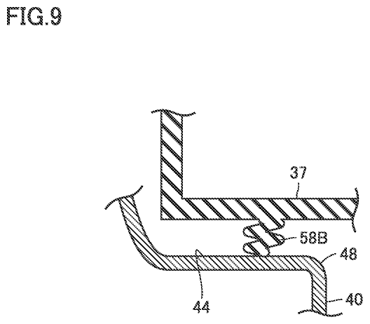

FIG. 9 is a cross-sectional view showing a configuration of a contact piece 58B as the second modification of contact piece 38 and a surrounding area of contact piece 58B. Contact piece 58B is formed in a so-called spring shape. Specifically, contact piece 58B is formed by deforming a plate-like member so as to be folded back several times. As contact piece 58B receives a load, it elastically deforms in the up-down direction and in the horizontal direction. Also, the lower end portion of contact piece 58B is in contact with mounting surface 44.

The modulus of elasticity of contact piece 58B can be adjusted, for example, by adjusting the number of times that the plate-like member is folded back, the angle at which the plate-like member is bent, and the like.

(Third Modification)

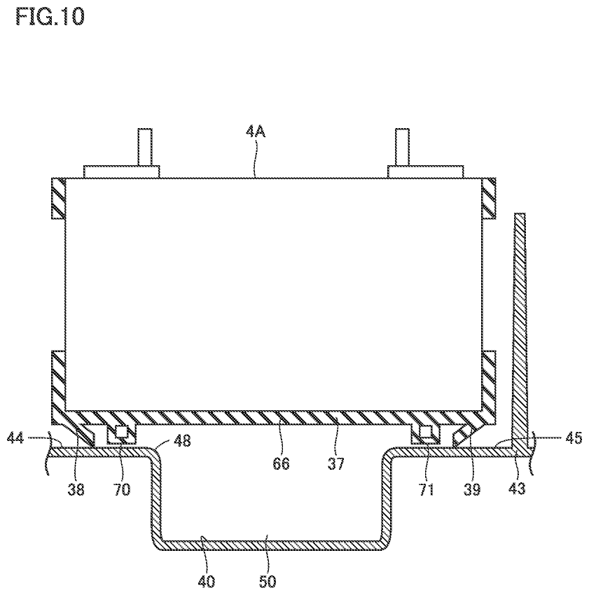

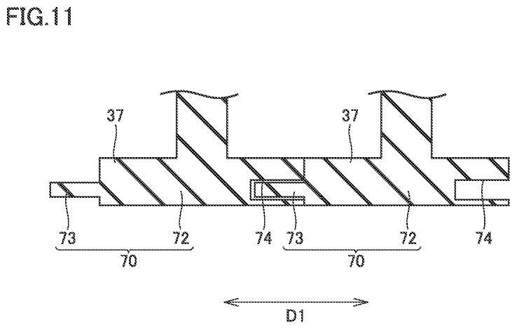

FIG. 10 is a front view showing a resin frame 66 as a modification of resin frame 21. FIG. 11 is a cross-sectional side view showing a part of resin frame 66.

Resin frame 66 has a bottom wall 37 provided with coupling portions 70 and 71. Except for coupling portions 70 and 71, the configuration of resin frame 66 is substantially the same as the configuration of resin frame 21.

Coupling portions 70 and 71 are formed on bottom wall 37, and also, spaced apart from each other in width direction W. A gap 63 is provided between coupling portions 70 and 71. Since coupling portion 71 is substantially the same as coupling portion 70, coupling portion 70 will be hereinafter mainly described.

In FIG. 11, coupling portion 70 includes a main body 72 and a protruding portion 73. Protruding portion 73 is formed so as to protrude from one end of main body 72 in longitudinal direction D1. Also, a recessed portion 74 is provided at the other end of main body 72 in longitudinal direction D1.

In coupling portions 70 adjacent to each other in longitudinal direction D1, protruding portion 73 of one coupling portion 70 is inserted into recessed portion 74 of the other coupling portion 70. Thereby, coupling portions 70 adjacent to each other are coupled to each other. Coupling portion 71 is also formed in the same manner as coupling portion 70. Thus, coupling portions 71 adjacent to each other in longitudinal direction D1 are also coupled to each other. Thereby, resin frames 66 adjacent to each other in longitudinal direction D1 are coupled to each other.

In resin frame 66, contact piece 38 is formed closer to side wall 35 than coupling portion 70, and contact piece 39 is formed closer to side wall 36 than coupling portion 71.

The lower end portions of contact pieces 38 and 39 are located below coupling portions 70 and 71, respectively. In other words, coupling portions 70 and 71 are not in contact with mounting surfaces 44 and 45, respectively. Therefore, also in the example shown in FIG. 11, contact pieces 38 and 39 elastically deform, and also, are in close contact with mounting surfaces 44 and 45, respectively.

In the example shown in FIG. 11, since resin frames 66 are coupled to each other, relative positional displacement of resin frames 66 can be suppressed. Thereby, formation of a large gap between contact pieces 38 of resin frames 66 can be suppressed. Similarly, formation of a large gap between contact pieces 39 can be suppressed. Thereby, the sealing performance achieved by contact pieces 38 and 39 can be improved.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage device comprising:
a housing case;
a power storage module including a plurality of power storage cells disposed inside the housing case; and
a plurality of resin frames each disposed between the power storage cells, wherein
a contact piece is formed on each of the resin frames, wherein the contact piece is in contact with an inner circumferential surface of the housing case and elastically deforms.

2. The power storage device according to claim 1, wherein
the housing case has a bottom surface provided with a recessed portion that opens upward,
the power storage module is disposed to close an opening of the recessed portion,
the power storage module closes the opening of the recessed portion to form a cooling passage through which cooling air flows, and
the contact piece is formed to come into contact with a portion of the inner circumferential surface, the portion being adjacent to an opening edge of the opening.

3. The power storage device according to claim 1, wherein
the power storage cells are arranged in an arrangement direction,
both ends of the power storage module are fixed to the housing case in the arrangement direction, and
the contact piece formed on one of the resin frames that is located at a center position in the arrangement direction is higher in modulus of elasticity than the contact piece formed on one of the resin frames that is located on one end position in the arrangement direction.

4. The power storage device according to claim 1, wherein
each of the resin frames includes
a bottom plate disposed on a lower surface of each of the power storage cells, and
a coupling portion formed on the bottom plate,
the coupling portions of the resin frames adjacent to each other are coupled to each other,
the contact piece protrudes downward from a lower surface of the bottom plate,
the contact piece protrudes downward below the coupling portion, and
the coupling portion is located apart from the inner circumferential surface of the housing case.
